(19) United States
(12) Patent Application Publication
(10) Pub. No.: US 2015/0049068 A1
(43) Pub. Date: Feb. 19, 2015

(54) LIQUID CRYSTAL DISPLAY PANEL AND 3D IMAGE SYSTEM

(71) Applicants: Qiaosheng Liao, Shenzhen (CN); Chia-chiang Hsiao, Shenzhen (CN); Chih-wen Chen, Shenzhen (CN)

(72) Inventors: Qiaosheng Liao, Shenzhen (CN); Chia-chiang Hsiao, Shenzhen (CN); Chih-wen Chen, Shenzhen (CN)

(73) Assignee: Shenzhen China Star Optoelectronics Technology Co., Ltd., Shenzhen (CN)

(21) Appl. No.: 13/522,965

(22) PCT Filed: May 9, 2012
(86) PCT No.: PCT/CN2012/075247

§ 371 Date: Jul. 19, 2012

(30) Foreign Application Priority Data
May 4, 2012 (CN) 201210137249.8

(51) Int. Cl. G09G 3/36; G06T 15/00

(52) U.S. Cl. CPC G09G 3/3648; G06T 15/00
USPC 345/206; 345/100

(57) ABSTRACT

The present invention provides a liquid crystal display panel and a 3D image system. The liquid crystal display panel comprises a first substrate, a second substrate, a liquid crystal layer. When display 3D images, pixels on predetermined rows are in a dark state, and at least three pixel rows are positioned between each adjacent two of the predetermined rows. In the present invention, the predetermined rows between adjacent two pixel units are in the dark state, thereby further enlarging the region of BM layer as well as solving the image crosstalk problem when displaying 3D images.

### FIELD OF THE INVENTION

The present invention relates to a field of a three-dimensional (3D) display technology, and more particularly to a liquid crystal display (LCD) panel and a 3D image system.

### BACKGROUND OF THE INVENTION

With the recent popularization 3D image system, requirements for the 3D system are getting higher and higher. A conventional 3D system comprises a LCD and 3D glasses, and the LCD comprises a thin film transistor (TFT) array substrate and a color filter (CF) substrate.

Referring to FIG. 1, FIG. 1 is a partially side view showing the conventional 3D system.

The LCD comprises pixels, and the pixels comprise left eye pixels 11 and right eye pixels 12, and each of the pixels has sub-pixels R, G and B. A black matrix (BM) 174 is disposed between the sub-pixels R, G and B. The 3D glasses have a first quarter-wave (λ/4) phase retarder 13 and a second λ/4 phase retarder 14 corresponding to the left eye glass 15 and the right eye glass 16.

When displaying 3D images, taking the left eye pixels 11 for example, light rays of the left eye pixels 11 are emitted to left eye glass 15 through the λ/4 phase retarder 13, and are then viewed by a user's left eye. At this time, there is a viewing angle θ between the light rays emitted from the left eye pixels 11 and the right eye glass 16. In the viewing angle θ, it is ensured that the light rays from the left eye pixels 11 are emitted into the left eye glass 15. When the light rays from the left eye pixels 11 exceed the viewing angle θ, the light rays from the left eye pixels 11 will be emitted into the right eye glass 16. As a result, a user's right eye will view the images from the left eye pixels 11, resulting in an image crosstalk as well as deteriorating the 3D display effect.

As a result, it is necessary to provide an LCD panel and a 3D image system to solve the problems existing in the conventional technologies, as described above.

### SUMMARY OF THE INVENTION

An object of the present invention is to provide an LCD panel, so as to solve the image crosstalk problem of the LCD when displaying 3D images.

For solving the above-mentioned problem, the present invention provides a liquid crystal display panel, and the liquid crystal display panel comprises: a first substrate including first electrodes and a black matrix layer; a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels; a liquid crystal layer disposed between the first substrate and the second substrate; a patterned retarder bonded to an outer side of the first substrate or the second substrate; source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows, and at least three pixel rows are positioned between each adjacent two of the predetermined rows; and gate driving chips connected to the scan lines and configured to input scan signals through the scan lines.

In the liquid crystal display panel of the present invention, each of the predetermined rows comprises one or more pixel rows.

In the liquid crystal display panel of the present invention, three pixel rows are positioned between each adjacent two of the predetermined rows.

In the liquid crystal display panel of the present invention, four pixel rows are positioned between each adjacent two of the predetermined rows.

Another object of the present invention is to provide an LCD panel, so as to solve the image crosstalk problem of the LCD when displaying 3D images.

For solving the above-mentioned problem, the present invention provides a liquid crystal display panel, and the liquid crystal display panel comprises: a first substrate including first electrodes and a black matrix layer; a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels; and a liquid crystal layer disposed between the first substrate and the second substrate; wherein, when display 3D images, the pixels on the predetermined rows are in a dark state, and at least three pixel rows are positioned between each adjacent two of the predetermined rows.

In the liquid crystal display panel of the present invention, each of the predetermined rows comprises one or more pixel rows.

In the liquid crystal display panel of the present invention, the liquid crystal display further comprises: source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows; and gate driving chips connected to the scan lines and configured to input scan signals through the scan lines.

In the liquid crystal display panel of the present invention, three pixel rows are positioned between each adjacent two of the predetermined rows.

In the liquid crystal display panel of the present invention, four pixel rows are positioned between each adjacent two of the predetermined rows.

In the liquid crystal display panel of the present invention, the liquid crystal display further comprises a patterned retarder bonded to an outer side of the first substrate or the second substrate.

Still another object of the present invention is to provide a 3D image system, so as to solve the image crosstalk problem of the LCD when displaying 3D images.

For solving the above-mentioned problem, the present invention provides a 3D image system comprising 3D glasses and a liquid crystal display panel, wherein the 3D glasses comprises quarter-wave phase retarders, and the liquid crystal display panel comprises: a first substrate including first electrodes and a black matrix layer; a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels; and a liquid crystal layer disposed between the first substrate and the second substrate; wherein, when display 3D images, the pixels on the predetermined rows are in a dark state, and at least three pixel rows are positioned between each adjacent two of the predetermined rows.

In the 3D image system of the present invention, each of the predetermined rows comprises one or more pixel rows.

In the 3D image system of the present invention, the liquid crystal display panel further comprises: source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows; and gate driving chips connected to the scan lines and configured to input scan signals through the scan lines.

In the 3D image system of the present invention, three pixel rows are positioned between each adjacent two of the predetermined rows.

In the 3D image system of the present invention, four pixel rows are positioned between each adjacent two of the predetermined rows.

In the 3D image system of the present invention, the liquid crystal display panel further comprises a patterned retarder bonded to an outer side of the first substrate or the second substrate.

In the liquid crystal display panel of the present invention, when displaying 3D images, the common voltage are inputted to the pixels on predetermined rows through the data lines by the source driving chips. At the same time, the pixel signals are inputted to the pixels on other rows except the predetermined rows through the data lines. In this case, three pixel rows are positioned between each adjacent two of the predetermined rows, and three pixels can form a pixel unit. In that manner, the predetermined rows between the adjacent two pixel units are in the dark state, thereby further enlarging the region of the BM layer as well as solving the image crosstalk problem when displaying 3D images.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a partially side view showing a conventional 3D system;

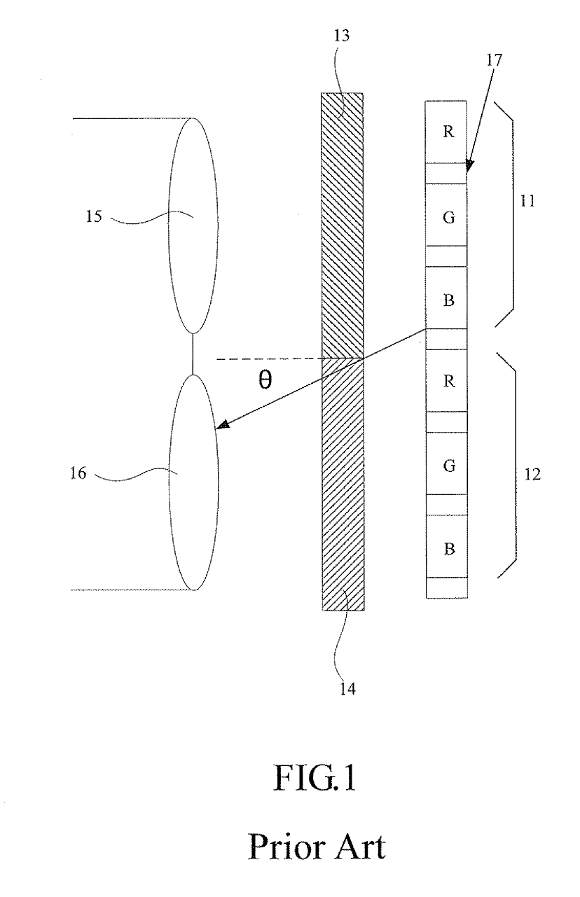

FIG. 2 is a cross-sectional view showing a liquid crystal display panel according to the present invention;

FIG. 3 is a schematic diagram showing the LCD panel according to the present invention; and

FIG. 4 is a schematic diagram showing the LCD panel when displaying 3D images according to the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto. In the drawings, structure-like elements are labeled with like reference numerals.

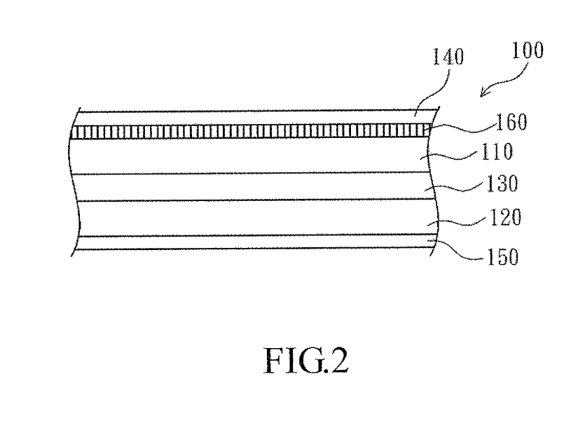

FIG. 2 is a cross-sectional view showing a liquid crystal display (LCD) panel according to a preferred embodiment of the present invention.

Referring to FIG. 2 again, a partially cross-sectional view showing the LCD panel according to the preferred embodiment of the present invention is illustrated. The LCD apparatus of the present embodiment can comprise the liquid crystal display panel 100 and a backlight module (not shown). The liquid crystal display panel 100 is disposed opposite to the backlight module, and the backlight module may be realized as a side lighting backlight module or a bottom lighting backlight module to provide the liquid crystal display panel 100 with the back-light.

Referring to FIG. 2 again, the LCD panel 100 may comprise a first substrate 110, a second substrate 120, a liquid crystal layer 130, a first polarizer 140 and a second polarizer 150 and a patterned retarder 160. The liquid crystal layer 130 is formed between the first substrate 110 and the second substrate 120. That is, the liquid crystal layer 130 is positioned at inner sides of the first substrate 110 and the second substrate 120. The first polarizer 140 is disposed at an outer side of the first substrate 110, and the second polarizer 150 is disposed at an outer side of the second substrate 120. The patterned retarder 160 is bonded to the outer side of the first substrate 110 or the second substrate 120.

Referring to FIG. 2, the first substrate 110 and the second substrate 120 may be realized as glass substrates or flexible plastic substrates. The first substrate 110 may be a glass substrate or other material substrate with color filters (CF), and the second substrate 120 may be a glass substrate or other material substrate with a thin film transistor (TFT) array. It notes that the CF and the TFT array may also be disposed on the same substrate in other embodiments.

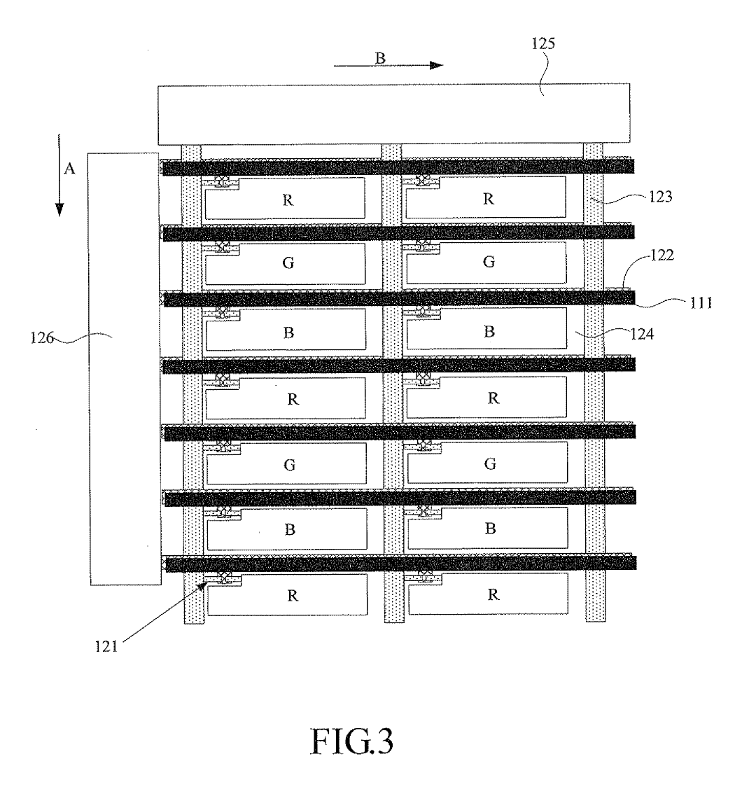

Referring to FIG. 3, FIG. 3 is a schematic diagram showing the LCD panel according to the preferred embodiment of the present invention.

The second substrate 120 includes switch elements 121, second electrodes (not shown), scan lines 122 and data lines 123. The scan lines 122 and the data lines 123 are intersected vertically in a matrix manner, and a plurality of pixels 124 are defined there-between. In this preferred embodiment, the pixels 124 comprise pixels R, pixels G and pixels B. The data lines 123 extend along a column direction A, and a row direction B is vertical to the column direction A, wherein the pixels R are arranged along the row direction B, and the pixels G are arranged along the row direction B, and the pixels B are arranged along the row direction B. Along the column direction A, the pixels R, the pixels G and the pixels B are arranged as the so called tri-gate pixel structure. Furthermore, along the column direction A, a black matrix (BM) layer is disposed on the first substrate 110 and between each adjacent two of the pixels R, G or B. More specifically, the BM layer of the first substrate 110 corresponds to the scan lines 122 of the second substrate 120.

Referring to FIG. 3 again, the LCD panel of the present invention further comprises source driving chips 125 and gate driving chips 126. In this case, the gate driving chips 126 are connected to the scan lines 122, and the source driving chips 125 are connected to the data lines 123. When displaying 2D images, the source driving chips 125 input pixel signals to the pixels R, G or B through the data lines 123, and the gate driving chips 126 input scan signals to the pixels R, G or B through the scan lines 122. At this time, an electrode voltage is formed on the second electrodes in the pixels R, G or B, and a voltage difference is formed between the electrode voltage and a common voltage of the first electrode (not shown) of the first substrate 110, thereby forming a electric field to drive liquid crystal molecules of the liquid crystal layer 130 to rotate, and thus light rays can or not pass through the liquid crystal layer 130 to form different images.

When displaying 3D images, the pixels on predetermined rows L are in a dark state. In practice, each of the predetermined rows L may comprise one or more pixel rows. At least three pixel rows are positioned between each adjacent two of the predetermined rows. For example, three adjacent pixels R, G and B are positioned between the predetermined rows, and the three adjacent pixels R, G and B can form a pixel unit for displaying images. Certainly, in other embodiments, the pixel unit may comprise pixels R, G, B and Y (yellow). That is, four pixel rows are positioned between each adjacent two of the predetermined rows L.

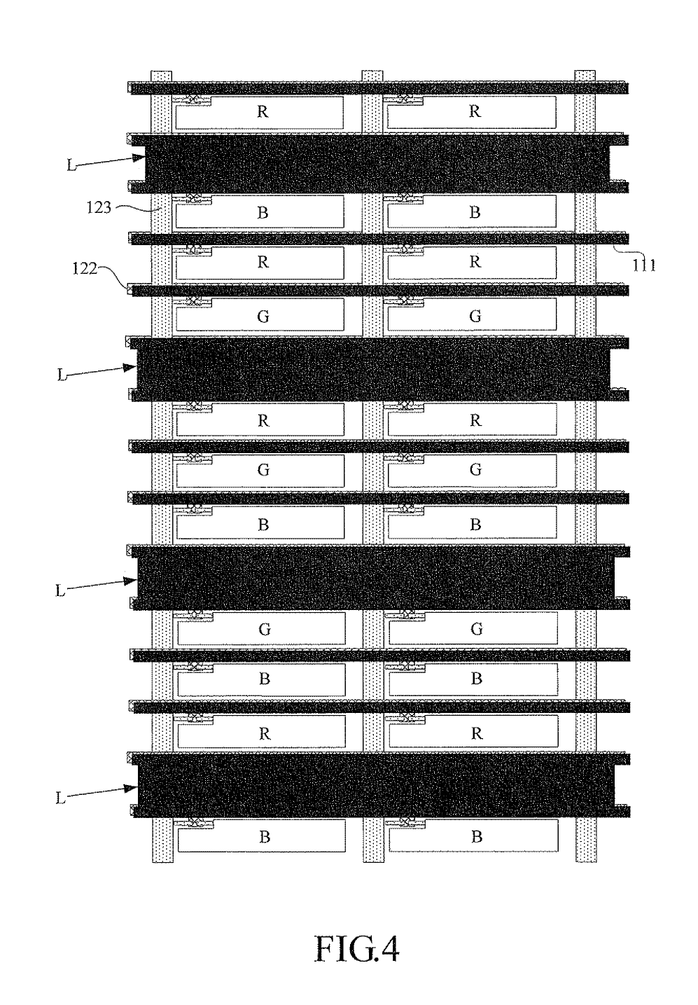

In this case, the source driving chips 125 input the common voltage to the pixels on the predetermined rows L (referring to FIG. 4) through the data lines 123, and the common voltage can also inputted to the pixels on the predetermined rows L through common lines (not shown) of the second substrate 120. Pixel signals are inputted to the pixels on other rows except the predetermined rows L by the source driving chips 125, and scan signals are inputted to the pixels through the scan lines 122 by the gate driving chips.

Referring to FIG. 4, FIG. 4 is a schematic diagram showing the LCD panel when displaying 3D images according to the present invention. The common voltage inputted to the pixels on the predetermined rows L of the second substrate 120 is identical to the common voltage (Vcom) inputted to the first electrode of the first substrate 110. Therefore, when displaying 3D images, the liquid crystal molecules of the liquid crystal layer 130 in the pixels on the predetermined rows L do not rotate, such that light rays can not pass through the liquid crystal molecules, and thus the pixels on the predetermined rows L are in a dark state. At the same time, the source driving chips 125 input the pixel signals to the pixels on other rows except the predetermined rows L through the data lines 123, and the scan lines 122 input the scan signals to the pixels through the scan lines 122, and thus the voltage difference is formed between the voltage of the pixels on other rows except the predetermined rows L and the common voltage of the first electrode of the first substrate 110 for varying a tilting angle of the liquid crystal molecules in the liquid crystal layer 130. A pixel unit for displaying images is positioned between each adjacent two of the predetermined rows L which are in the dark state. The pixel unit between each adjacent two of the predetermined rows comprises the pixel (or sub-pixels) is configured to display images, and the pixels in the dark state (on the predetermined rows L) can act as another BM for enlarging the region of the BM layer. Therefore, when viewing the 3D images, a viewing angle can be increased for mitigating the image crosstalk problem.

In practice, according to different requirements, the common voltage can be inputted to adjacent two or more pixel rows through the data lines 123 for one predetermined row L as described above, thereby further enlarging the region of the BM layer.

The present invention further provides a 3D image system comprising 3D glasses and the above-mentioned LCD panel. The 3D glasses can comprise quarter-wave phase retarders. The LCD panel is described above and shown in FIG. 2 through FIG. 4, and is not mentioned herein for simplification.

In the present invention, when displaying 3D images, the common voltage are inputted to the pixels on predetermined rows through the data lines by the source driving chips. At the same time, the pixel signals are inputted to the pixels on other rows except the predetermined rows through the data lines, and the scan signals are inputted to the pixels on other rows except the predetermined rows through the scan lines. In this case, one pixel unit is positioned between each adjacent two of the predetermined rows. In that manner, the predetermined rows between the adjacent two pixel units are in the dark state, thereby further enlarging the region of the BM layer as well as solving the image crosstalk problem existing in the conventional LCD with tri-gate structure.

The present invention has been described with a preferred embodiment thereof and it is understood that many changes and modifications to the described embodiment can be carried out without departing from the scope and the spirit of the invention that is intended to be limited only by the appended claims.

1. A liquid crystal display panel, comprising:
a first substrate including first electrodes and a black matrix layer;
a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels;
a liquid crystal layer disposed between the first substrate and the second substrate;
a patterned retarder bonded to an outer side of the first substrate or the second substrate;
source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows, and at least three pixel rows are positioned between each adjacent two of the predetermined rows; and
gate driving chips connected to the scan lines and configured to input scan signals through the scan lines.

2. The liquid crystal display panel according to claim 1, wherein each of the predetermined rows comprises one or more pixel rows.

3. The liquid crystal display panel according to claim 1, wherein three pixel rows are positioned between each adjacent two of the predetermined rows.

4. The liquid crystal display panel according to claim 1, wherein four pixel rows are positioned between each adjacent two of the predetermined rows.

5. A liquid crystal display panel, comprising:
a first substrate including first electrodes and a black matrix layer;
a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels; and
a liquid crystal layer disposed between the first substrate and the second substrate;
wherein, when display 3D images, the pixels on the predetermined rows are in a dark state, and at least three pixel rows are positioned between each adjacent two of the predetermined rows.

6. The liquid crystal display panel according to claim 5, wherein each of the predetermined rows comprises one or more pixel rows.

7. The liquid crystal display panel according to claim 5, further comprising:
source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows; and
gate driving chips connected to the scan lines and configured to input scan signals through the scan lines.

8. The liquid crystal display panel according to claim 5, wherein three pixel rows are positioned between each adjacent two of the predetermined rows.

9. The liquid crystal display panel according to claim 5, wherein four pixel rows are positioned between each adjacent two of the predetermined rows.

10. The liquid crystal display panel according to claim 5, further comprising a patterned retarder bonded to an outer side of the first substrate or the second substrate.

11. A 3D image system comprising 3D glasses and a liquid crystal display panel, wherein the 3D glasses comprises quarter-wave phase retarders, and the liquid crystal display panel comprises:
a first substrate including first electrodes and a black matrix layer;
a second substrate including switch elements, second electrodes, scan lines and data lines, wherein a plurality of pixels are defined by the intersected scan lines and data lines, and the second electrodes are disposed in the pixels and connected to the switch elements, respectively, and the data lines extend along a column direction, and a row direction is vertical to the column direction, and the pixels are arranged along the column direction, and the black matrix layer corresponds to the scan lines between the pixels; and
a liquid crystal layer disposed between the first substrate and the second substrate;
wherein, when display 3D images, the pixels on the predetermined rows are in a dark state, and at least three pixel rows are positioned between each adjacent two of the predetermined rows.

12. The 3D image system according to claim 11, wherein each of the predetermined rows comprises one or more pixel rows.

13. The 3D image system according to claim 11, wherein the liquid crystal display panel further comprises:
source driving chips connected to the data lines, wherein, when display 3D images, the source driving chips are configured to input a common voltage to the pixels on predetermined rows through the data lines such that the pixels on the predetermined rows are in a dark state, and pixel signals are inputted to the pixels on other rows except the predetermined rows; and
gate driving chips connected to the scan lines and configured to input scan signals through the scan lines.

14. The 3D image system according to claim 11, wherein three pixel rows are positioned between each adjacent two of the predetermined rows.

15. The 3D image system according to claim 11, wherein four pixel rows are positioned between each adjacent two of the predetermined rows.

16. The 3D image system according to claim 11, wherein the liquid crystal display panel further comprises a patterned retarder bonded to an outer side of the first substrate or the second substrate.
